(19) United States
(12) Patent Application Publication
(10) Pub. No.: US 2016/0283839 A1
(43) Pub. Date: Sep. 29, 2016

(54) SECRETARY-MIMICKING ARTIFICIAL INTELLIGENCE FOR PATHOLOGY REPORT PREPARATION

(71) Applicant: Jay J. Ye, Bangor, ME (US)

(72) Inventors: Jay J. Ye, Bangor, ME (US); Chung Ho Shum, Bangor, ME (US)

(21) Appl. No.: 15/072,736

(22) Filed: Mar. 17, 2016

Related U.S. Application Data
(60) Provisional application No. 62/136,873, filed on Mar. 23, 2015.
(60) Provisional application No. 62/148,267, filed on Apr. 16, 2015.

(51) Int. Cl. G06N 3/00; G10L 15/22

(52) U.S. Cl. CPC G06N 3/006; G10L 15/22; G10L 2015/223

(57) ABSTRACT

A method of using artificial intelligence (e.g., SMILE) to assist users, such as pathologists and pathologist assistants, in pathology report preparation is described. The method includes the steps of (1) specimen gross examination, submission and dictation, (2) final diagnosis dictation, and (3) Cancer Protocol Templates construction. SMILE “listens” to the voice commands, “reads” case/slide information, goes through algorithms, and engages in report preparation. SMILE performs secretarial tasks, such as typing, error checking, important information announcing, and inputting commands by simulating keystrokes and mouse clicks, thus enabling the user to focus on the professional tasks at hand. This results in an increase in the efficiency for the user, and a decrease in reporting errors. Human-SMILE interaction is very much human-to-human like, mediated by voice recognition technology and text-to-speech. There is a significant reduction in the keyboard and mouse usage in comparison to either human transcription or voice recognition without SMILE.

### TECHNICAL FIELD

Various embodiments relate generally to artificial intelligence based systems, methods, devices and computer programs and, more specifically, relate to artificial intelligence intended for usage in pathology practice.

### BACKGROUND

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

Pathology is a medical specialty in which the practitioners (pathologists) render interpretations of tissue specimens. The interpretation is then conveyed to the treating physicians in the form of pathology reports.

The specimens are normally received within labeled specimen containers. After the tissue specimen(s) of a patient are received in the pathology department, the patient and specimen-related information is entered into pathology information system. The specimens are individually described by pathologists or pathologist assistants. In general, small biopsy specimens are directly placed in processor cassettes, while larger specimens require sectioning, with the sectioned tissue slices entirely or representatively placed in cassettes. The tissue within the cassettes is then submitted for processing and slide preparation. This step of tissue handling is documented in the pathology report under gross description. In addition, clinical information that is furnished by the clinician and that accompanies the specimens is also entered into pathology report, generally under Clinical Information.

After tissue processing and slide preparation, the slides become available for pathologists to evaluate under a microscope. In the straightforward situation, after evaluating the slides and taking the clinical information as well as gross description into consideration, pathologists render the interpretations. The interpretations are entered into the pathology report under Diagnosis or under Diagnosis and Microscopic Description/Comment. In more complex situations, additional studies, such as additional slides, special stains, immunohistochemistry studies and molecular studies may be required before a final interpretation is rendered.

Thus, the pathology reports generally consist of Clinical Information, Gross Description, and Diagnosis, with or without Microscopic Description/Comment.

In many cancer excision/resection specimens, the College of American Pathologists requires that the report include a formatted summary of the major attributes of the cancer, called Cancer Protocol Templates. The majority of the information included in the Cancer Protocol Templates is from Gross Description, Clinical Information and Diagnosis. Sometimes, the Templates contain information from the interpretations of one or more prior specimens.

Traditionally, pathology report preparation, at the steps of both specimen gross examination by the pathologist assistants and of slide interpretation by pathologist, is assisted by secretaries transcribing the dictations. Recently, voice recognition technology has started gaining popularity in pathology practice, replacing human transcription. This transition tends to decrease the report turn-around-time and reduce the costs attributable to secretarial staff. However, there is not only a concomitant shift of secretarial tasks to pathologist assistants and pathologists, but also the possibility of an increase in the number of nonsensical reporting errors (such as voice recognition errors).

Also recently, barcode scanning technology has become available as optional modules in certain pathology information systems. These systems track the specimens from arrival in the specimen containers, to placement in processor cassettes, to embedding into paraffin blocks, and finally to production of glass microscopes slides.

### SUMMARY

The below summary is merely representative and non-limiting.

The above problems are overcome, and other advantages may be realized, by the use of the embodiments.

In a first aspect, an embodiment provides an artificial intelligence [Secretary-Mimicking Artificial Intelligence (SMILE)] that assists pathologists and pathologist assistants in pathology report preparation at the steps of (1) specimen gross examination, submission and dictation, (2) final diagnosis dictation, and (3) Cancer Protocol Templates construction. SMILE “listens” to the voice commands, “reads” case/slide information, goes through algorithms, and engages in report preparation. SMILE performs secretarial tasks, such as typing, error checking, and interacting with the graphical user interface (GUI) by simulating keystrokes and mouse clicks, thus enabling the pathologists and pathologist assistants to focus on the professional tasks at hand. This results in an increase in the efficiency for the pathologists and pathologist assistants, and a decrease in reporting errors. Human-SMILE interaction is very much human-to-human like, mediated by voice recognition technology and text-to-speech. There is a significant reduction in the keyboard and mouse usage in comparison to either human transcription or voice recognition without SMILE.

In a further aspect, an embodiment provides a method of computer-assisted pathology report preparation. The computer being used to assist in the report preparation displays a cursor at a current cursor location in an active window. In response to determining a voice input regarding a report document has a command for the computer, the method also includes determining a current context of the computer, determining at least one instruction based on the command and the current context, and executing at least one instruction on the computer. The current context is based at least in part on the active window and the current cursor location.

### BRIEF DESCRIPTION OF THE DRAWINGS

Aspects of the described embodiments are more evident in the following description, when read in conjunction with the attached Figures.

FIG. 1 shows a diagram of the paths of a user-SMILE dialogue in accordance with an embodiment.

FIG. 2 shows a diagram of information gathering and document management during gross examination of specimen in accordance with an embodiment.

FIG. 3 shows a diagram of information gathering and document management during microscopic examination of specimen in accordance with an embodiment.

FIG. 4 illustrates a process of automatic typing of specimen headers in accordance with an embodiment.

FIG. 5 is a diagram of intent-centered communication and execution of a command in accordance with an embodiment.

FIG. 6 illustrates a screenshot of a graphical user interface (GUI) for SMILE to receive and memorize dictionary instruction from the user in accordance with an embodiment.

FIG. 7 illustrates a screenshot of a GUI for SMILE to receive and memorize header instruction from the user in accordance with an embodiment.

FIGS. 8A and 8B, collectively referred to as FIG. 8, illustrate a screenshot of a breast carcinoma template generated by SMILE in accordance with an embodiment.

FIG. 9 shows a block diagram of a system that is suitable for use in practicing various embodiments.

FIG. 10 is a logic flow diagram illustrating a method, and a result of execution of computer program instructions embodied on a memory, in accordance with an embodiment.

FIG. 11 is a diagram illustrating components of SMILE's intelligence in accordance with an embodiment.

### DETAILED DESCRIPTION

This patent application claims priority under 35 U.S.C. §119(e) from U.S. Provisional Patent Application No. 62/136,873, filed Mar. 23, 2015 and U.S. Provisional Patent Application No. 62/148,267, filed Apr. 16, 2015, the disclosures of which are incorporated by reference herein in their entirety.

An artificial intelligence designated as Secretary-Mimicking Artificial Intelligence (SMILE) has been created. Pathologists or pathologist assistants communicate with SMILE through both voice recognition and barcode scanning, and SMILE performs the secretarial tasks of report typing and error checking judiciously, communicating back to pathologists or pathologist assistants via text to speech and on-screen message boxes. Human-SMILE interaction is very much human like. Relieving the pathologist assistants and pathologists from the secretarial tasks, SMILE enables them to focus on the professional tasks at hand.

SMILE has been developed by two pathologists, Jay J. Ye, MD, PhD and Chung Shum MD, PhD. Dr. Ye is a board certified pathologist and dermatopathologist in practice for 16 years and a hobbyist computer programmer; he also serves as the medical director of the tissue gross examination room. Dr. Shum is a board certified pathologist and cytopathologist in practice for 8 years and a hobbyist computer programmer; he also serves as the medical director for the IT department. The reason that SMILE is powerful, pragmatic, and user friendly is due in no small part to the fact that its creators are practicing pathologists who constantly wrestle with the daily tasks of pathology report preparation.

During the preparation of a pathology report, (1) SMILE is intelligent, consisting of the abilities to perceive, think, and act; (2) the human-SMILE interface is human-to-human-like because of the voice dialogue and SMILE's ability to understand the intent of the user; and (3) when new situation is encountered, SMILE has the ability to learn so that it becomes more intelligent and more user-specific over time.

1. Smile is Intelligent:

SMILE's ability to perceive: perception is largely achieved by (a) listening to the voice commands, (b) reading the case and slide related information as well as the report text, and (c) finding out what windows are open and which window is active.

It is straightforward that listening to voice commands is mediated by voice recognition software such as Dragon Medical Practice Edition.

SMILE reads the case and slide related information by obtaining the information shortly after the contents of the slide scanning module (Advance Material Processing Module, AMP module) and/or the pathology information (PowerPath) case display are changed, either by keyboard and mouse operation or by scanning the bar code of the slides. In this particular embodiment, once the bar code of a slide of a new case is scanned, the display in AMP module changes. In addition, information on a new case is brought up on the computer screen. Through a continuous looping mechanism, these changes are perceived by SMILE. From the PowerPath case information windows, SMILE obtains the information such as case number, patient's name, gender, age, list of specimen(s), preliminary report text (final report preparation stage), submitting physician's name, and so on. From the AMP windows, SMILE obtains the case number and slide label. From the database, SMILE obtains information such as paraffin blocks submitted for processing, immunostains ordered, CPT code for each specimen, and report text for all the previous specimens from the patient with the current specimen. Also, SMILE is aware who the user is.

Some of the above information either directly obtained (such as gender, slide label and submitting physician), or is extracted after text comprehension, such as the list of slides the case contains according to the gross description (derived from reading and analyzing the text of gross description), saved in txt files, the Windows registry, or system clipboard, so as to be available for different processes triggered by voice command subsequently.

Knowing what windows are open and which one is active enables SMILE to perform the document management function (See SMILE's ability to act).

SMILE's ability to think: Thinking happens at several levels.

At the most rudimentary levels, SMILE processes the information obtained by reading. According to the preference of the users, SMILE can make certain announcements, such a patient's name, specimen label that this associated with the scanned slide, patient's age, possible dictation errors in the clinical information and or gross description (final report preparation stage), and possible error in the section code (also at the final report preparation stage).

At the intermediate level of thinking, during report text entry, SMILE guides the cursor in the document to the appropriate location so that interpretation will always be entered into the correct section of the report. This is achieved by SMILE's awareness of which slide the user has most recently scanned.

At the highest level, SMILE's thinking is manifested as judicious and semi-autonomous actions in executing the voice commands; SMILE achieves this by taking the information that SMILE reads and retains in consideration when responding to the voice commands.

Since SMILE's thinking is ultimately reflected in its action, it will be described in greater details in how SMILE acts.

SMILE's ability to act: By the nature of the action, SMILE's action consists of windows automation mainly by keyboard and mouse simulation and text entry into certain fields in the windows and the report. By the purpose of the action, SMILE's action includes (a) document management, (b) cursor management, and (c) situation-appropriate response to voice commands.

In one, non-limiting embodiment, a word processing program, such as Microsoft Word, serves as an add-in for report text input. Whenever a slide is scanned, the AMP window becomes the active window, e.g., the window that receives the keyboard or voice input. This would have interrupted the report text entry into the word processor document by the user if the user scans a slide, since scanning will make the word processor window no longer active, e.g., no longer the window to receive keyboard or voice input. SMILE overcomes this by making the word processor windows active if the word processor window becomes inactive due to slide scanning; however, a mouse click to the AMP window or PowerPath window is interpreted as user intent and the word processor windows will not be activated.

After the tissue specimen(s) of a patient are received in the pathology department, the patient and specimen-related information is entered into pathology information system. The pathologists or pathologist assistants (designated as PA) will start the process of tissue gross examination, with or without dissection, and submitting tissue for processing and slide preparation. At this step, the report preparation consists of dictating Clinical Information and Gross Description into the preliminary report. Some reports also contain Intraoperative consultation (frozen section diagnosis). Once the PA scans the barcode on the first specimen container of a case, the AMP window and PowerPath case information window will be activated. SMILE subsequently opens the word processor document corresponding to the case, generating a default template report, taking into consideration the number of specimens, patient's name, patient's date of birth, specimen labels, and PA's name and including all these items in the report template. The report template consists of both a section for Clinical Information and a section for Gross Description. Place holders are included in the report template for the ease of navigation within the report by voice commands.

When dictating the section codes for the gross description, SMILE is aware of the cursor location in the document. The PA can furnish the information on the sequential labeling of the section code and SMILE will know which specimen the sections are for. For example, a section code 3A denotes the first section from specimen number 3 and 3B denotes the second section from specimen number 3, and so on.

At the end of dictation when the PA gives a command to save the preliminary report, SMILE will read the preliminary report; when certain voice recognition errors are detected, the PA will be notified of the presence of such possible errors. In some situations, SMILE would automatically correct the errors. Also, SMILE can remind PAs to order certain additional test. For instance, GMS stain when clinical history indicates dermatitis.

After the slides become available, pathologists will evaluate them under a microscope and make interpretations, taking into consideration the clinical information as well as the gross description. The interpretations are entered into the pathology report under Diagnosis or under Diagnosis and Microscopic Description/Comment. Most commonly, when a pathologist is ready to start the report preparation, one can use a command “Diagnosis” or “Begin dictation”. Upon hearing this command, SMILE would go from the PowerPath window into a word processor window and automatically generate specimen headers and place holders for the diagnosis text for each specimen. Scanning the barcode of a slide from a different specimen would move the cursor in the document to the correct location for diagnosis text entry. After the dictation for the case is completed, a command “Release case” would electronically finalize the case.

The following paragraphs will further elaborate on different intelligent aspects of SMILE:

If a slide of a different case is scanned, SMILE will notify the user that a slide of a different case is scanned and the word processor window will become inactive (with an option of locking the word processor window in an inactive state). This is a mechanism to ensure that diagnosis is always entered into the correct case/correct patient.

Knowing the slide label of the slide the user just scanned, SMILE knows which specimen this slide belongs to, and therefore moves the cursor to the appropriate location for text entry. This cursor management by SMILE is random access; thus the user can start dictating the diagnosis for any specimen in a multiple specimen case. It is also repeatable, regardless whether there is already text entered for that particular specimen. This is a mechanism to ensure that within the same multi-specimen cases, the interpretation always goes to the right specimen. In this non-limiting embodiment, in order for this function of SMILE to work, the pathologists must scan every slide of the case.

The situation-appropriate response to the voice commands is a major result of SMILE's thinking. In straightforward situations, such as ordering certain histology tasks (e.g., performing additional levels, special stains, immunostains and molecular tests), SMILE would simply execute the command faithfully and unvaryingly. The user has the option of having SMILE type out what has been ordered in the preliminary report automatically after SMILE places the orders.

Automatic generation of diagnosis headers is one of the major tasks that SMILE performs. One important component of SMILE is its ability to automatically type in the headers of the specimens, including obtaining the starting material from the specimen list, expanding the abbreviations, removing the extraneous words (e.g., “mole”, “basal cell carcinoma”, “cancer”), rearranging the order of the words, adding tissue source (e.g., skin, prostate, mucosa) in front of the label when indicated, and, most challengingly, putting in the correct procedure for each header, particularly in multiple-specimen cases. After the user gives a command of “Diagnosis”, SMILE will go from the PowerPath case information window into a word processor window and type in the headers for all of the specimens and well as the placeholders for the diagnosis for each specimen. During this process, SMILE reads the preliminary report, including the specimen list, clinical information and gross description, extracts the relevant information and comes up with appropriately standardized specimen label and the corresponding procedure for each specimen.

Building upon the ability to generate specimen headers autonomously, SMILE can also receive commands with specific diagnoses, such as “Basal cell carcinoma, superficial type” from pathologist, and type the diagnosis of the entire specimen with one command, without the need to say “Diagnosis” first.

Further concatenation of actions enables the pathologist to complete the report preparation for a single-specimen case with one command. For example, if the diagnosis is “Inflamed and irritated seborrheic keratosis,” a command such as “Release case ISK” will notify SMILE to go from the PowerPath case information window into the word processor, automatically type the specimen headers, type the diagnosis “Inflamed and irritated seborrheic keratosis.”, and electronically finalize the case in PowerPath. This entire process takes roughly 11 seconds. After giving the command, the pathologist can focus the attention on the next case while SMILE is executing the actions. If SMILE has any doubt about any aspect in the preliminary report, such as possible error in clinical information, gross description, specimen label or gender, SMILE will type the report, communicate the findings to the pathologist and stop one step before electronically releasing the case, giving the pathologist the chance for additional verification.

Some composite commands enable SMILE to “understand” the intent of the pathologists more intelligently. For instance, in a 6-part prostate biopsy case, the command “Benign prostatic tissue times 6” will type the diagnoses for the entire case. Alternatively, if one has already dictated “Benign prostatic tissue” for any specimen, scanning a slide from the next specimen and issuing a command “Repeat diagnosis times 5” will also produce the same result. If the case has one specimen with cancer and all of the others are benign, one can scan the slide of the specimen with cancer, then say “Others benign prostatic tissue”, and all of the other specimens will have the diagnosis of “Benign prostatic tissue.” The cursor then will stop at the specimen with cancer. One can proceed with the free-text diagnosis for that particular specimen.

SMILE is versatile in meeting the needs or preferences of both the clinicians the pathologists and the specific requirements of certain cases. For example, a dermatologist requested that for multiple-specimen cases, the sequential designation to be capitalized alphabet rather than the usual Arabic numeral in order for the pathology report to fit well with the designation of specimens/lesions in his electronic medical record. Also, the dermatologist does not want the header to start with “Skin”. SMILE ensures that this specific requirement is met on every multiple-specimen case from his office, automatically generating headers such as “A. Right distal dorsal forearm, punch biopsy:” instead of a default format of “1. Skin, right distal dorsal forearm, punch biopsy:”. Another example is that rare physicians insist on microscopic description for every one of their cases; on these cases, SMILE generates an audible reminder of “please dictate a microscopic description.”

Pathologist-specific composite commands can be easily constructed. For instance, many times a day, when encountering punch biopsies for certain inflammatory dermatoses, a pathologist may tend to order a GMS stain and then level through the entire punch biopsy in 8 levels. A command called “Skin protocol 1” orders GMS and level through the block in 8 levels sequentially, then performs the action triggered by command “Diagnosis” (e.g., type in the header and do the regular checking, proofreading and announcing if applicable as described above), then types in red-colored font “**GMS and 8 levels through the blocks ordered on 1A**”.

Case-specific reminders are also available, such as a reminder for repeating a HER2 test in the excision specimen in grade III breast cancer cases if HER2 is negative in the biopsy and a reminder for submitting more tissue in order to obtain more than 12 lymph nodes in the colectomy specimen for colon cancer.

SMILE also has the ability to notify the user of possible gender error in the pathology information system by both the first name of the patient and by specimen type/report text. For instance, a patient with the first name “David” and assigned gender as female, or a patient named “Mary” and assigned gender as male, would prompt SMILE to question the correctness of gender in the system. Gender-specific specimens are also recognized by SMILE; for instance, vasectomy specimens (specimens that belong to male patients only) and an assigned patient gender of female will also prompt SMILE to warn pathologist the existence of a gender assignment error in the PowerPath database.

SMILE is autonomous in making many decisions. For example, in certain types of specimens, over 90% percent of time the diagnosis is the same. Hearing the command “Diagnosis”, SMILE not only puts in the header, but also types in the default diagnosis. These include, but are not limited to, the vast majority of the gross examination only specimens, vasa deferentia, fallopian tubes for tubal ligation, cardiac valves, sleeve gastrectomy specimens for morbid obesity, etc. In addition to the automatic typing of the default diagnosis, SMILE can automatically correct errors in the report text (mostly nonsensical combination of words and grammatical errors), such as “melanin A” instead of “Melan A”, or “Clinical inflammation” instead of “Clinical information”, or “No malignancy is not identified” instead of “No malignancy is identified”, or “may suggests” instead of “may suggest”.

This ability to correct the nonsensical combination of words and grammatical errors is above and beyond the ability of traditional voice recognition software (such as Dragon) to correct individual words. Some of the traditional voice recognition software word combination errors seem to be quite recalcitrant to training. The utility of this proofreading capability is not limited to pathology, it can also be used in other specialties of medical practice to proofread the dictations.

As mentioned previously, in many cancer diagnoses on specimens that completely or nearly completely remove the entire lesion, the College of American Pathologists requires that the report include a formatted summary of the major attributes of the cancer. These summaries are known as Cancer Protocol Templates. The construction of Cancer Protocol Templates is usually the last step in the report preparation and can be quite burdensome, mostly involving putting the information that is already in the report in a formatted fashion.

At this point, the report contains clinical information, gross description and diagnosis for each specimen in the case. In addition, some information needed in the Templates may reside in a previous report. For instance, breast cancer excision specimens are frequently preceded by a needle core biopsy that contains the diagnosis as well as the results of ancillary studies, such as estrogen receptor, progesterone receptor and Her2 gene amplification status. In this case, the user can ask SMILE to read the prior report, remember the case number, and remember the results of estrogen receptors, progesterone receptors, and Her2. In one, non-limiting embodiment, the information is remembered in the windows registry.

After this the user can ask SMILE to generate a breast cancer template, SMILE would read the clinical information, gross description, and the microscopic diagnosis for each specimen; SMILE would retrieve the ancillary study results from the windows registry; then SMILE would ask the user to reconfirm the size information of the tumor, and to respond to the nodal information. After that, SMILE would generate a template with many entries prepopulated, including the stage. In this process, SMILE intelligently extracts the relevant information from the report and uses it for the template. SMILE' s assistance makes this normally burdensome task more bearable for the pathologists.

After the final report preparation is complete, when the pathologist gives the command “Release case”, SMILE has the capability to make sure that all the slides described in the gross description have been scanned before the case can be finalized electronically. This not only ensures that the pathologist has looked at all the slides before finalizing the case, it also enables the pathologist to catch certain types of section code errors in the gross description. Even before this step during the slide review process, missing section code designation and ambiguous section code designation would have been caught by SMILE and communicated to pathologist.

2. Human-to-Human like Interface:

Voice command is an important modality to trigger SMILE to perform tasks. The use of voice recognition and text-to-speech enables the human-machine interface to be mediated by voice. Since SMILE is triggered by precise commands, measures are taken to make SMILE more error tolerant and have the ability to understand user intents. These include: execution of the command in a (a) context-dependent fashion; (b) active document-dependent fashion; and (c) the inclusion of multiple synonymous commands for identical execution. This enable the users to focus on the substance, e.g., the contents of what one needs to say rather than the numerous commands the user needs to remember, thus making this voice interface even more human like. These will be illustrated below through the following examples.

Take the command “Consult Dr. so and so” as an example. After the pathologist has finished dictating the diagnosis for a case and he or she would like another pathologist to consult on the case, the user can use the above command. If there is not a punctuation mark at the end of the diagnosis, SMILE will automatically add a period to the end of the diagnosis, then move the cursor to two lines beneath the diagnosis of the last specimen. At that location, SMILE will type: “Comment: Dr. so and so has reviewed this case and concurs.”. Then SMILE will save the case and progress the case electronically to the internal consult stage (peer review stage) for the intended pathologist. If the case has a “Comment” and the same command is used at the end of the dictation for the comment, SMILE will simply type the sentence “Dr. so and so has reviewed this case and concurs.” and perform the case progression electronically as above. If the pathologist has already dictated a sentence stating that Dr. so and so has reviewed the case (it does not need to be worded precisely as above), SMILE will not do any typing. Instead, it will simply progress the case electronically to the intended pathologist. If the pathologist has finished dictating the case, including the diagnosis and the narrative comment, and decides to modify the previously dictated diagnosis text, at the end of the modification, the same command will move the cursor down to the end of the comment and add the regular sentence such as “Dr. so and so has reviewed this case and concurs.” and then forward the case electronically to the intended pathologist. As one can tell from the above description, at the end or near the end of the final diagnosis dictation, in the commonly encountered situation, no matter where the cursor is located in the document, a command “consult Dr. so and so” will enable SMILE to complete the tasks variably and appropriately according to the situation.

If this same command is used when the active window is not the word processor but PowerPath, SMILE assumes that no typing is needed and simply progress the case electronically to the intended pathologist.

The above example demonstrates the execution of commands by SMILE in both context-dependent and active window-dependent fashions.

All of the commands that trigger the typing of different diagnoses, which constitute the majority of the voice commands, may also be executed in active window-dependent fashion.

The above two principles delegate the complexity to the machine side of the human-machine (SMILE) interface, making the human experience of interaction simple and pleasurable.

A third principle is to use multiple synonyms for the same command, so that the user does not need to remember the exact command, e.g., SMILE will almost invariably do the right thing no matter what the user says after enough synonyms are included. For instance, “begin dictation”, “begin diagnosis”, and “diagnosis” are synonyms, and “BCC superficial”, “superficial BCC”, “BCCS” and “Basal cell carcinoma superficial type” will all cause SMILE to type the diagnosis “Basal cell carcinoma, superficial type.”

3. Adaptability that Allows Growth and Customization:

SMILE is adaptable by receiving user teaching from dialogue boxes: SMILE's ability to correct spelling errors in the specimen list and nonsensical word combination errors in clinical information, gross description, and final diagnosis dictation can be taught by using dialogue boxes, enabling any non-programming user to improve SMILE's intelligence in correcting complex word combination over time. During the dictation, the nonsensical combination “Clinical inflammation” was noted. “Clinical inflammation” is highlighted. The user hits a hotkey to bring up a dialogue box. Both the Wrong text and correct text boxes are prepopulated by the phrase “Clinical inflammation”. The user then changes the text in the “Correct text” box to “Clinical information”. After that, the user clicks the button “OK to Edit”. This action changes the highlighted text in the report to “Clinical information” and simultaneously this knowledge is committed to memory by SMILE in the format of a .txt file.

SMILE's ability to give warning/reminder can be trained in similar fashion.

Customizing the diagnoses for individual pathologists is also done by using dialogue boxes. Through teaching by using a similar but more complex dialogue box, one can have SMILE generate specimen headers according to one's preference. For instance, a 3-specimen case with specimen list of “1. Cecal polyp: 2. Sigmoid bx: 3. Upper rectal polyp”, SMILE could automatically generate three headers for a user as “1. Cecal polyp, biopsy:”, “2. Sigmoid colon, biopsy:” and “3. Upper rectal polyp, biopsy:”. When a different pathologist gives the same command “Diagnosis”, because of their preference and prior training of SMILE, SMILE generates the following three headers for that user: “1. Mucosal polyp (cecum), biopsies:”, “2. Mucosa (sigmoid colon), biopsies:”, and “3. Mucosal polyp (upper rectum), biopsies:” This dialogue box allows the user to teach SMILE to make logical judgment contingent upon the presence or absence of certain key phrases in certain parts of the pathology report, enabling SMILE to do the conversion in a judicious fashion.

The advantage of using a GUI to improve and customize SMILE is to give the power and control to the users, so that this artificial intelligence, SMILE, can evolve over time to fit better and better with both the user's specific practice environment (e.g., the type of cases, clinicians' way of labeling the specimens, procedure used, PA's way of dictations, errors encountered and so on) and the user preference.

While programming languages, such as AutoHotkey, may be used to obtain information from windows, other programming languages, such as Visual Basic for Application (VBA), may be used to obtain report text. Alternatives include other languages such as AutoIt to get windows information or languages which directly interact with a dynamic-link library (DLL) of the operating system.

SMILE may also interrogate the system clock to select the appropriate PA processor run orders; including AHK ImageSearch command to look for “blue dots” on PowerPath tabs indicating the presence of Notes and Concurrent cases, and an absence of History (equivalent to “new patient”, triggering a “New Patient” check routine, such as one that announces DOB, sex, and opens the requisition.

Conclusion:

In summary, SMILE' s ability to obtain nonverbal information, to manage the documents on the desktop, and to manage the cursor in the document for report text entry, combined with the algorithms, allows SMILE to effectively perform the vast majority of the secretarial tasks, as well as some tasks that are not routinely performed by secretaries, during report preparation. Examples of the latter may include announcing the relevant prior history of the patient such as prior malignancy based on the previous specimens, making sure that the paraffin block designation in the gross description matches the actual submission, preventing pathologists from finalizing the report without mentioning all the special studies (such as immunostains and special stains) that have been performed, etc.

The use of voice recognition and text-to-speech makes the human-SMILE interaction similar to a dialogue. The delegation of complexity to the SMILE side in the user-SMILE interface enables SMILE to have the appearance of understanding the human intent and the liberal use of synonyms makes the interaction more human like and pleasant.

There is also a significant reduction in the use of keyboard typing and mouse movement.

The user is thus relieved from the burden of mundane yet important secretarial tasks, and is able to concentrate on the professional tasks that only the pathologists are trained to perform.

Encounter-based learning is a wonderful feature of SMILE; SMILE constantly learns and adapts by receiving inputs from user through dialogue boxes, resulting in a continual increase in the knowledge based intelligence and in the ability to tailor to the specific preferences of the users. This teaching process is both easy and convenient. The user does not need to have programming knowledge

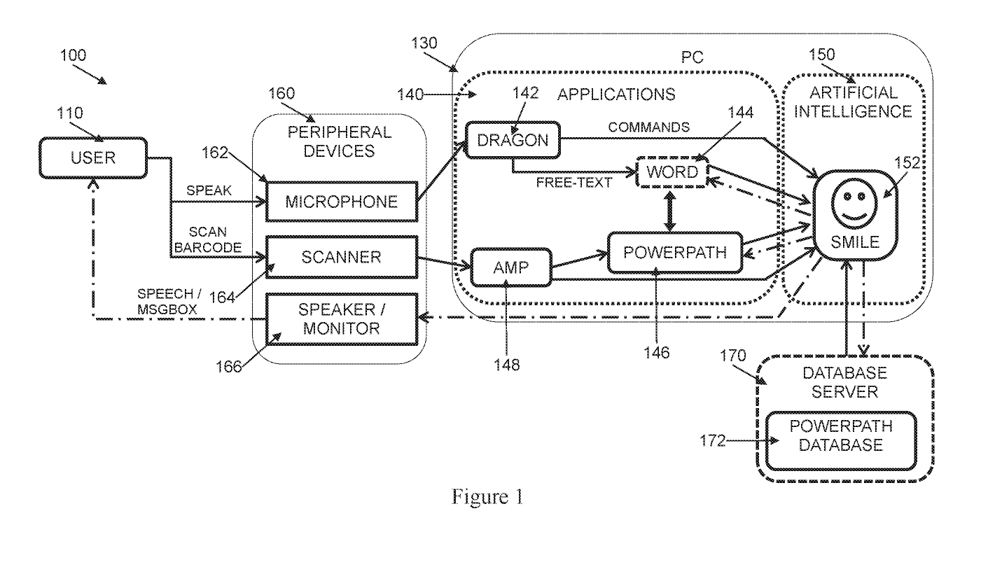

FIG. 1 shows a diagram 100 of the paths of a user-SMILE dialogue: The paths of dialogue are shown between a user 110, such as a pathologist or pathologist assistant, and SMILE 152. In this, non-limiting example, additional applications/software 142 running on a PC 130 are being used—Dragon 142: medical Dragon; PowerPath 146: PowerPath client; AMP 148: advanced material processing module of PowerPath; and Word 144: Microsoft Word Add-in for PowerPath. The dialogue between the pathologist 110 and SMILE 152 is mediated via computer peripheral devices 160 and commercially available applications and their modules. The scanning of the barcode of a new slide causes certain changes in an AMP window, and/or changes in a PowerPath Client window if the slide is of a different case. These changes are detected by the artificial intelligence 150 program SMILE 152. When a pathologist 110 speaks into the microphone 162, if it is interpreted by Medical Dragon 142 as a free-text dictation, the text will be typed into the active window on the screen, usually the Word Add-in 144, without going through SMILE 152. If the speech is interpreted by Medical Dragon 142 as a voice command, some sequence in SMILE 152 will be executed. SMILE 152 communicates with the pathologists 110 via text-to-speech and/or message box using output device 166, such as speakers and/or monitors. SMILE 152 can communicate with local memory devices (not shown) of the PC 130 and can also communicate with a database server 170 in order to access additional information, such as a PowerPath database 172.

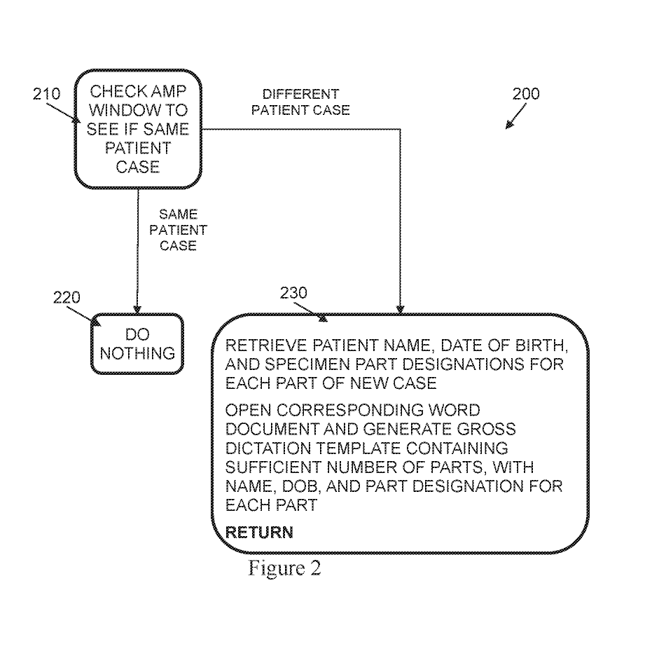

FIG. 2 shows a diagram 200 of specimen bottle barcode scan-driven perpetual loop for information gathering and document management during gross examination of specimen. This perpetual loop is specimen barcode scan-driven, implemented by using an automation scripting language, such as Autohotkey. It runs once every second to see if a new specimen container has been scanned that belongs to a new patient case in Block 210. When no new specimen container is scanned, the loop simply does nothing in Block 220.

If a specimen container belonging to a new case is scanned, the new case information is retrieved and stored (including patient name, date of birth, and specimen designations for each part of multi-part cases). The corresponding word processor document will be opened, and an appropriately-sized gross dictation template is generated, which includes the patient name, date of birth, and part designations as shown in Block 230

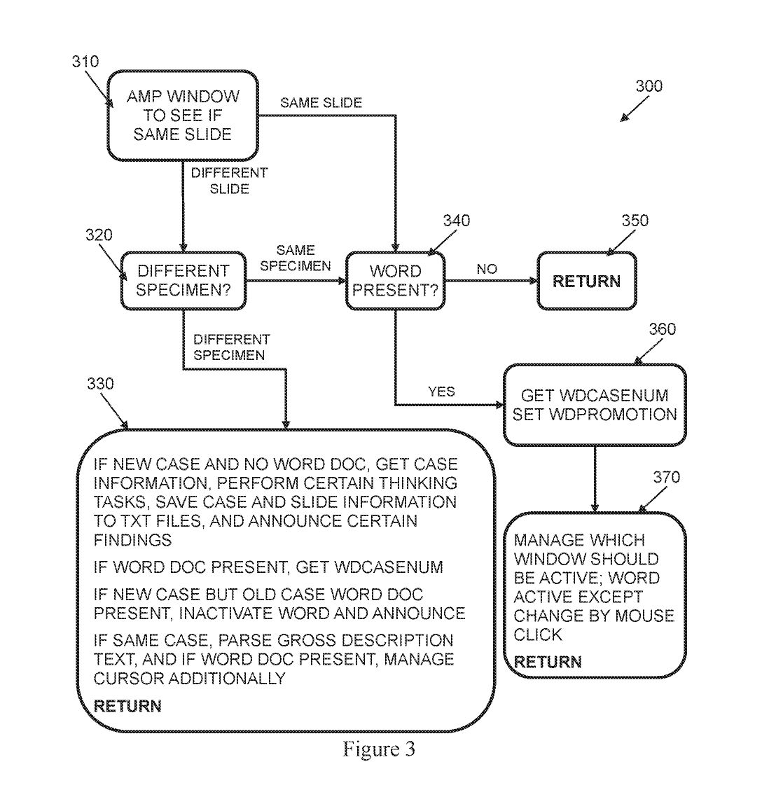

FIG. 3 shows a diagram 300 of a slide barcode scan-driven perpetual loop for information gathering, document management, and cursor management during the report preparation by pathologist. As in FIG. 2, this perpetual loop is slide barcode scan-driven, implemented by using an automation scripting language. In this embodiment, the loop runs once every half a second to see if a new slide is scanned in Block 310.

When no new slide is scanned and no word processor document is open for text entry (checked in Block 340), the loop simply does nothing at Block 350. If the word processor document corresponding to the case is open for text entry, the loop will get the word processor document title to make sure that the right word processor document is open at Block 360 and set a mechanism to have the word processor document activated if it becomes inactive for any reason other than actual mouse clicking at Block 370. In conventional systems a document may become inactive by repeat scanning of the same slide.

If the AMP window text indicates that a different slide has been scanned, the next branching point is whether the newly scanned different slide belongs to a different specimen or the same specimen at Block 320. If the new slide belongs to the same specimen, the subsequent handling is identical to the same slide situation described above and progresses to Block 340. If the new slide belongs to a different specimen the process proceeds to Block 330.

In Block 330, if the slide belongs to a different specimen but the same case, SMILE will parse the gross description of the specimen, and, if the corresponding word processor document is present, SMILE will move the cursor to the correct location for text entry. If the slide belongs to a new case and no word processor document is open, SMILE will gather new case information, perform certain thinking tasks, save the case and slide information to text files, and announce certain findings. If the slide belongs to a new case and the word processor document of the old case is still open, SMILE will push the word processor document to the back and notify the user that a “slide of a different case has been scanned” to prevent diagnosis text being entered into the wrong case.

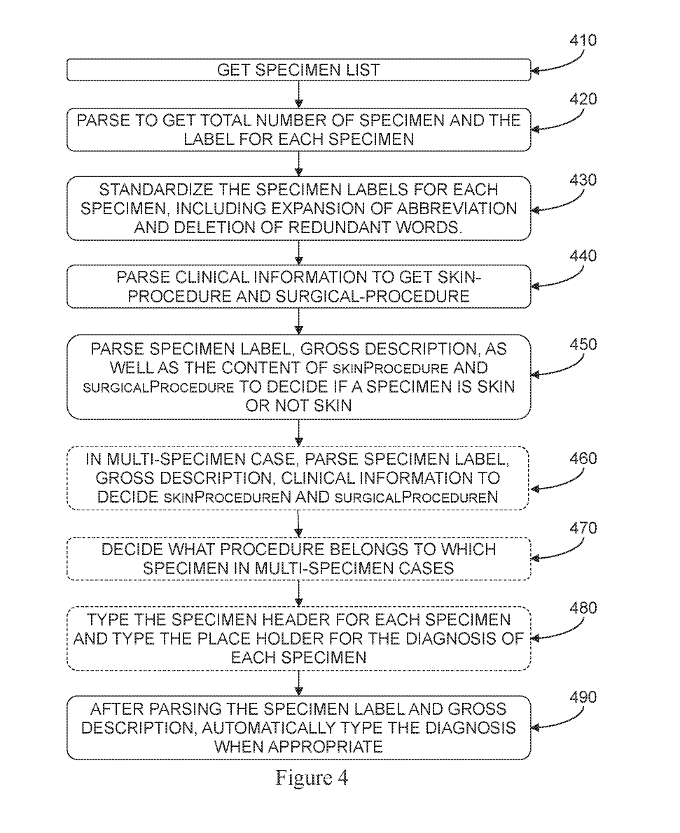

FIG. 4 illustrates the process of automatic typing of specimen headers. In the Diagnosis portion of the pathology report, the diagnosis for each specimen may be preceded by one line of header, consisting of optional tissue type, specimen label, and procedure. An example is “Skin, left upper arm, 4 mm punch biopsy:” where “Skin” is tissue type, “left upper arm” is the specimen label, and “4 mm punch biopsy” is the procedure. This process is shown in FIG. 4.

The process begins at Block 410 where a specimen list is received. At Block 420 the specimen list is parsed to get a total number of specimen and the label for each specimen. The specimen labels for each specimen are standardized, including expansion of abbreviation and deletion of redundant words at Block 430.

At Block 440 any clinical information is parsed to get skinProcedure and surgicalProcedure. The variable “skinProcedure” is used to contain procedures to procure the skin specimen, “surgicalProcedure” is a variable used to store procedures that are used to procure specimens other than skin. The specimen label, gross description, as well as the content of skinProcedure and surgicalProcedure are parsed at Block 450 to decide if a specimen is skin or not skin.

In multi-specimen cases, at Block 460, specimen label, gross description, clinical information are parsed to decide skinProcedureN and surgicalProcedureN. The variables “surgicalProcedureN” and “skinProcedureN” store procedures that are more likely to be used for a particular specimen in a multi-specimen case. Their assignment takes the specimen label, gross description and clinical information into consideration. The final assignment of the procedure to a particular specimen in a multi-specimen case is a balancing act amongst the above 4 variables. At Block 470 a decision is made as to what procedure belongs to which specimen. The specimen header for each specimen and the place holder for the diagnosis of each specimen are typed in at Block 480.

After parsing the specimen label and gross description, the process proceeds to Block 490 and automatically types the diagnosis when appropriate. In certain situations, the headers of a specimen, in conjunction with the gross description for that specimen, will trigger SMILE to automatically type a default diagnosis.

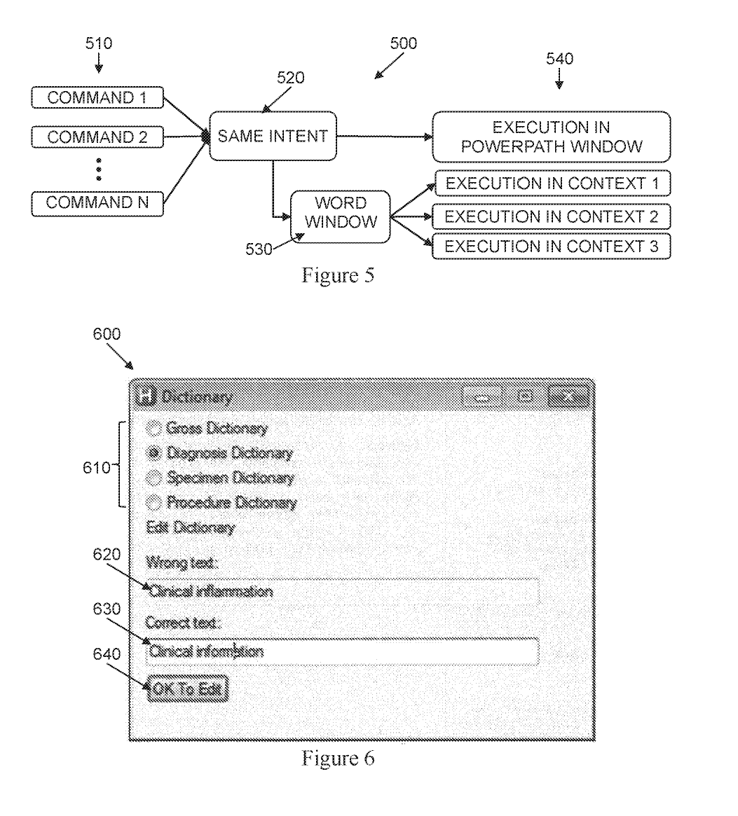

FIG. 5 is a diagram 500 of intent-centered communication and execution of a command. The intent can be the common denominator of the communication from the user to SMILE. Different commands 510 may be used to express the same intent 520. The same intent is then executed differently depending upon which window is active, for example, if the word processor window is active 530, the same intent is executed in a text- and cursor-dependent fashion.

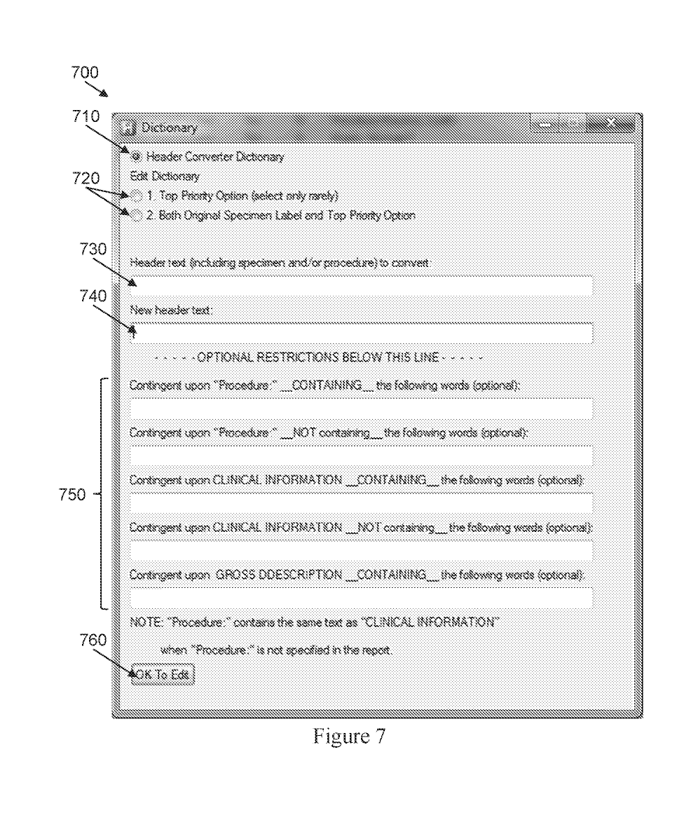

FIG. 6 illustrates a screenshot of a simple graphical user interface (GUI) 600 for SMILE to receive and memorize instruction from the user. The user is provided a series of buttons 610 which allows them to select which dictionary the instruction should update. The GUI also includes a “Wrong text” field 620 to show the text to be corrected and a “Correct text” field 630 where the user may input the correction. By clicking the “OK To Edit” button 640, the selected dictionary is updated so that future instances of the text in the “Wrong text” field 620 can be automatically replaced with the correction. This GUI may also be used to automatically expand abbreviations and/or to enable various shortcuts.

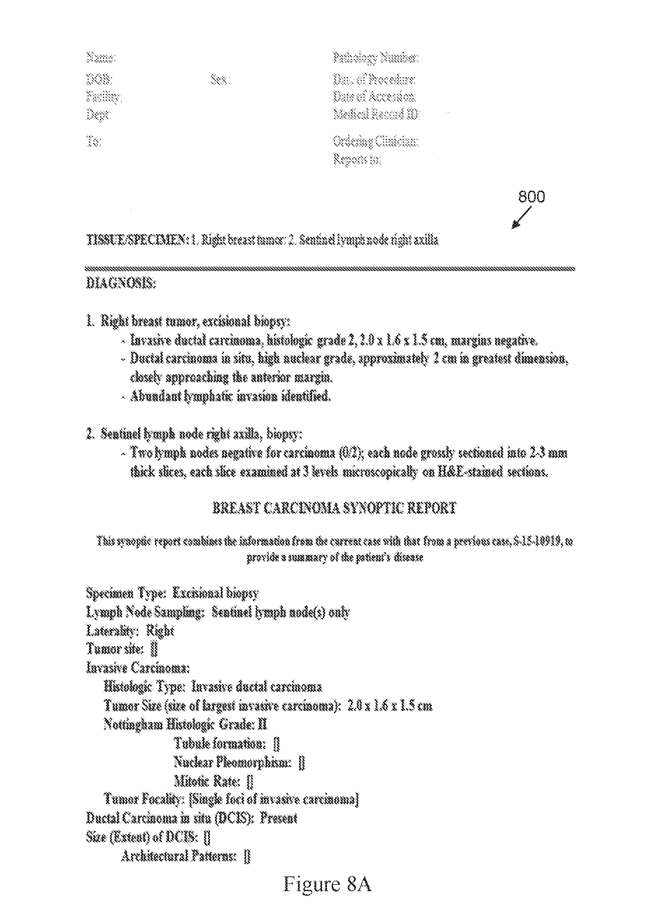

FIG. 7 illustrates a screenshot of a complex GUI 700 for SMILE to receive and memorize header instruction from the user in accordance with an embodiment. Button 710 selects the dictionary to be edited while buttons 720 provided additional options for the instructions being created. Field 730 allows entry of the header text to be changed and Field 740 provides a space for the user to provide the replacement text. Fields 750 allow the user to optionally specify replacement text to be used only when various contingent options are satisfied. Clicking the “OK To Edit” button 640 updates the selected dictionary accordingly.

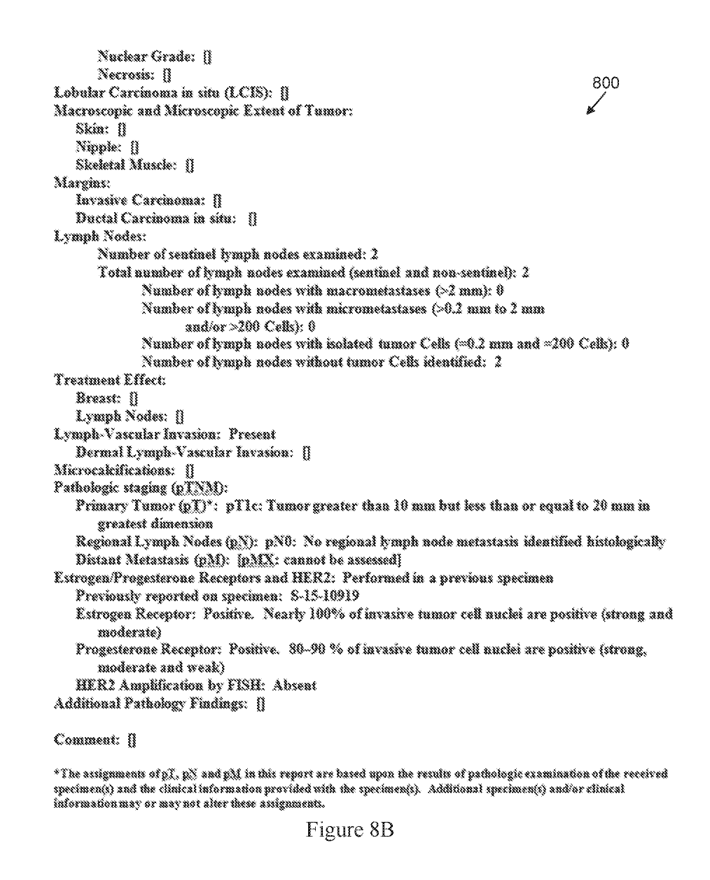

FIG. 8 illustrates a screenshot 800 of a breast carcinoma template generated by SMILE, prepopulating the entries by the following approaches: gathering some information by reading one or more previous biopsy reports (such as determining Estrogen/Progesterone Receptors and HER2 data, and a previous biopsy case number), gathering additional information by reading the current report (such as Specimen Type, Laterality, Histologic Type, Nottingham Histologic Grade, etc.), gathering information provided by the user through dialogue boxes (such as the information under the Lymph Nodes heading), and gathering information arrived at by logical reasoning (such as Lymph Node Sampling data and Pathologic staging (pTNM) data). Using the information from such non-verbal sources, SMILE is able to fill out the template with details not provided by dictation alone. This enables SMILE to provide a more effective machine-user interface making it more intuitive to use.

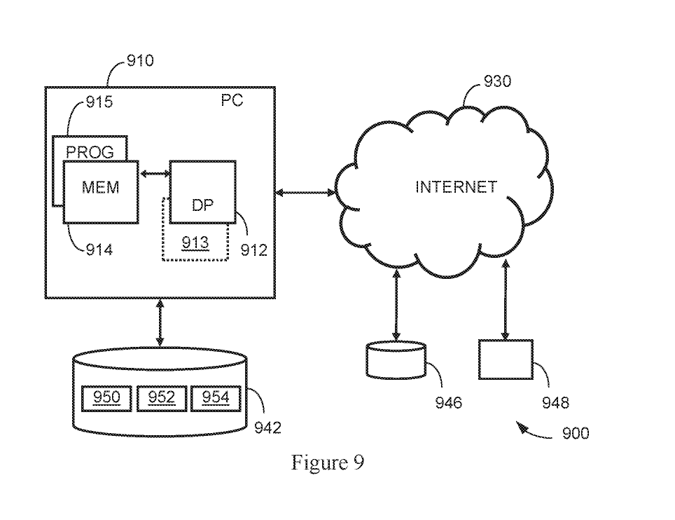

FIG. 9 shows a block diagram of a system 900 that is suitable for use in practicing various embodiments. In the system 900 of FIG. 9, the PC 910 includes a controller, such as a data processor (DP) 912 and a computer-readable medium embodied as a memory (MEM) 914 that stores computer instructions, such as a program (PROG) 915. PC 910 may communicate, for example, via the internet 930 with other devices such as database 946 and server 948. PC 910 may also include a dedicated processor, for example a speech recognition processor 913.

Databases 942, 946 may be connected directly to the PC 910 or the internet 930. As shown, database 942 stores a template database 950, dictionary files 952 and patient information 954; however, this information may be stored separately (or together) in another local or remote database, such as remote database 946.

The program 915 may include program instructions that, when executed by the DP 912, enable the PC 910 to operate in accordance with an embodiment. That is, various embodiments may be carried out at least in part by computer software executable by the DP 912 of the PC 910, by hardware, or by a combination of software and hardware. Additionally, various embodiments may be performed by PC 910, server 948 or both.

In general, various embodiments of the PC 910 may include tablets and computers, as well as other devices that incorporate combinations of such functions.

The MEM 914 and databases 942, 946 may be of any type suitable to the local technical environment and may be implemented using any suitable data storage technology, such as magnetic memory devices, semiconductor based memory devices, flash memory, optical memory devices, fixed memory and removable memory. The DP 912 may be of any type suitable to the local technical environment, and may include general purpose computers, special purpose computers, microprocessors and multicore processors, as non-limiting examples.

As described above, various embodiments provide a method, apparatus and computer program(s) to use artificial intelligence to assist in completing pathology practice tasks.

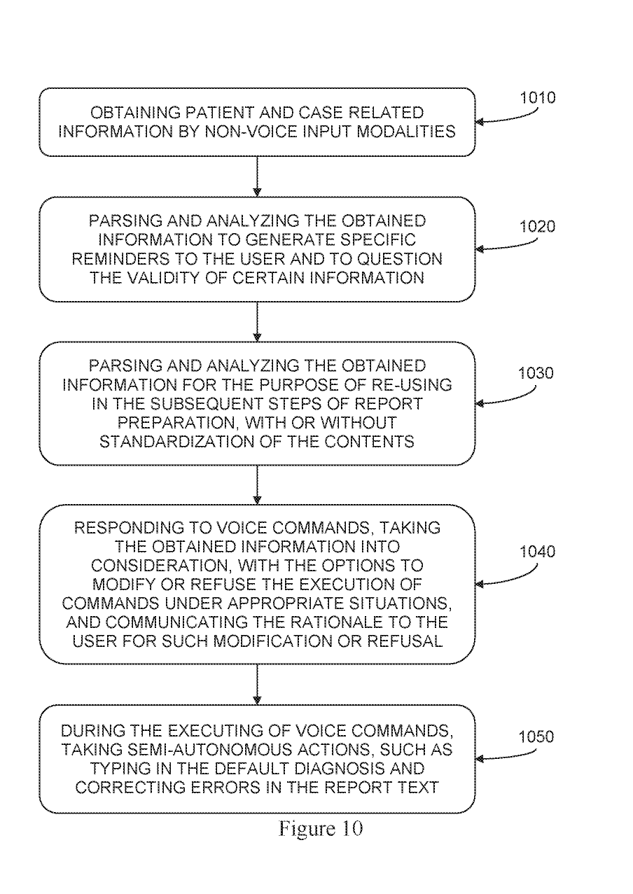

FIG. 10 is a logic flow diagram that illustrates a method, and a result of execution of computer program instructions, in accordance with various embodiments. In accordance with an embodiment a method performs, at Block 1010, a step of obtaining patient and case related information by non-voice input modalities, e.g., without conscious effort from the user. At Block 1020, the method performs a step of parsing and analyzing the obtained information to generate specific reminders to the user and to question the validity of certain information. A step of parsing and analyzing the obtained information for the purpose of re-using in the subsequent steps of report preparation, with or without standardization of the contents is performed at Block 1030. Voice commands are responded to by taking the obtained information into consideration, with the options to modify or refuse the execution of commands under appropriate situations, and communicate to user the rationale for such modification or refusal. At Block 1050, the method performs a step of executing of voice commands, taking semi-autonomous actions, such as typing in the default diagnosis and correcting errors in the report text.

In a further embodiment of the method above, responding to voice commands is based on an awareness of what documents are open. The method may also include managing the documents for receiving voice input.

In another embodiment of the method above, responding to voice commands is based on an awareness of the cursor location and the label of the most recently scanned slide, the method further comprising moving the cursor to the correct location for report text entry.

In a further embodiment of the method above, the method also includes using voice recognition technology, text to speech (TTS), graphical user interface (GUI) automation (keyboard and mouse click simulation), and different computer programming algorithms, to provide an artificial intelligence that performs secretarial tasks for pathologists and pathologist assistants, with a human-to-human like voice interface. These tasks include both text entry and GUI automation, sometimes composited and or concatenated, so that so that SMILE can perform a complex sequence of action in response to a single command.

Both the utilization of multiple command names for the execution of the same tasks and the utilization of identical command name for the same intent but with different execution sequences make the user-SMILE interaction more human like and significantly reduces the burden of the need for the user to remember exact command names and to remember what to use under what environment, e.g., when which document is active, etc.

In a further embodiment of the method above, the method also includes using a dialogue box for a user to train SMILE so as to both increase the knowledge data base of SMILE and SMILE's ability to perform tasks meeting the user's specific preference.

In another embodiment of the method above, the method also includes (a) gathering information from previous biopsy reports, from the dictated text in the current specimen report, and (b) in conjunction with information furnished by user via dialogue box, as well as SMILE's logical reasoning, prepopulating a significant number of entries in the Cancer Templates.

The various blocks shown in the Figures may be viewed as method steps, as operations that result from use of computer program code, and/or as one or more logic circuit elements constructed to carry out the associated function(s).

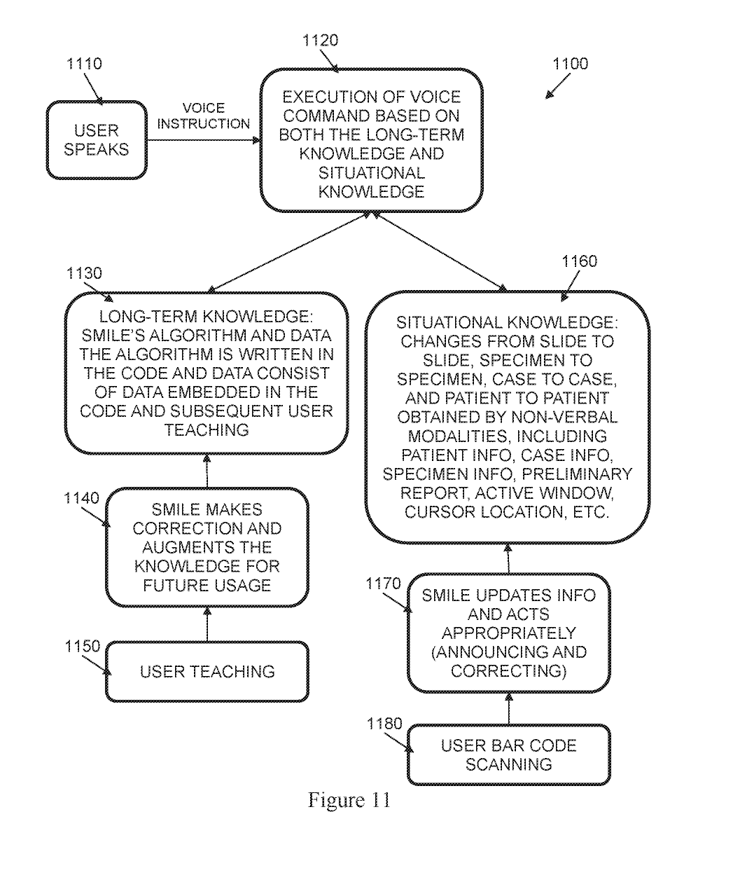

FIG. 11 is a diagram 1100 illustrating components of SMILE's intelligence in accordance with an embodiment. A user is able to speak at Block 1110. The voice instructions provided by the user are then executed based on both long-term knowledge and situational knowledge at Block 1120. Long-term knowledge, shown in Block 1130, is based on SMILE's algorithm and data. When a user provides teaching instructions, such as in Block 1150, SMILE makes corrections and augments the knowledge data for the future usage as in Block 1140.

Situational knowledge is specific to the situation. As shown in Block 1160, this type of knowledge includes patient info, case info, specimen info, preliminary report, active window, cursor location, etc. This type of knowledge changes from slide to slide, specimen to specimen, case to case, and patient to patient, as a consequence of slide bar code scanning. SMILE updates the relevant information and acts appropriately (announcing and correcting) in Block 1170 when updated of changes in the situation, for example, by having the user scanning the bar code of a new specimen/slide as in Block 1180.

Another embodiment provides a method for computer-assisted pathology report preparation. A computer displays a cursor at a current cursor location in an active window. In response to determining a voice input regarding a report document includes a command for the computer (such as a determination made by Medical Dragon 142 of FIG. 1), the method includes determining a current context of the computer. The current context is based at least in part on situational knowledge, the active window and the current cursor location. The situational knowledge includes information regarding a current user, a current patient, a current case, a current specimen and/or a current slide. At least one instruction is determined based on information stored in long-term knowledge data files, the command and the current context. The information stored in the long-term knowledge data files includes program defined instructions and user taught instructions. The method also includes executing the at least one instruction on the computer.

In a further embodiment of the method above, the method includes, in response to determining the voice input includes dictation, inputting text into an active window at the current cursor location based on the dictation.

In another embodiment of any one of the methods above, the voice input includes a combination of dictation and at least one command.

In a further embodiment of any one of the methods above, the current specimen is a first specimen. The method also includes receiving a scanned barcode associated with a second specimen and, in response to determining that the second specimen is a different slide of the first specimen, ensuring a text editor is the active window. The method may also include, in response to determining the second specimen is a different from the first specimen, accessing case information for the second specimen, parsing gross description text and placing the cursor at a new cursor location in the report document based at least in part on the gross description text.

In another embodiment of any one of the methods above, the method includes accessing case information for a specimen and generating the report document by loading specimen information and the case information into a report template. Generating the report document may include accessing a specimen list and for each specimen in the specimen list, adding a specimen header and a diagnosis placeholder into the report document. Generating the report document may also include automatically typing a diagnosis to replace a diagnosis placeholder based at least in part on a label for a specimen in the specimen list and a gross description.

In a further embodiment of any one of the methods above, the method includes accessing case information for the report document and automatically verifying consistency of case information and gross description. Automatically verifying consistency may include determining whether a potential gender error. The method may also include, in response to detecting a potential inconsistency, notifying a user of the potential inconsistency.

In another embodiment of any one of the methods above, the command is a request to finalize and release the report document. The at least one instruction may include instructions to determine that all slides described in a gross description have been scanned.

In a further embodiment of any one of the methods above, the current specimen is a first specimen. The method also includes receiving a scanned barcode associated with a second specimen and, in response to receiving the scanned barcode, updating the situational knowledge regarding the second specimen. Updating the situational knowledge may include updating the current patient, the current case, the current specimen and/or the current slide.

In another embodiment of any one of the methods above, determining at least one instruction includes accessing at least one dictionary file. Entries in the at least one dictionary file describe the program defined instructions and the user taught instructions. The user taught instructions may include instructions to automatically replace entered text with alternative language. Automatically replacing the entered text may include automatically expanding abbreviations, automatically rearranging an order of words in the entered text, automatically adding a tissue source in front of a label and/or automatically putting in correct procedures for each header in the report document.

Another embodiment provides an apparatus, such as a computer, for computer-assisted pathology report preparation. The apparatus includes a processor and a memory storing computer program code. The memory and the computer program code are configured to, with the processor, cause the apparatus to perform actions. In response to determining a voice input regarding a report document includes a command for the computer, the actions include determining a current context of the computer. The current context is based at least in part on situational knowledge, the active window and the current cursor location. The situational knowledge includes information regarding a current user, a current patient, a current case, a current specimen and/or a current slide. At least one instruction is determined based on information stored in long-term knowledge data files, the command and the current context. The information stored in the long-term knowledge data files includes program defined instructions and user taught instructions. The actions also include executing the at least one instruction on the computer.

In a further embodiment of the apparatus above, the memory and the computer program code are further configured to cause the apparatus to, in response to determining the voice input includes dictation, input text into an active window at the current cursor location based on the dictation.

In another embodiment of any one of the apparatus above, the voice input includes a combination of dictation and at least one command.

In a further embodiment of any one of the apparatus above, the current specimen is a first specimen. The actions also include receiving a scanned barcode associated with a second specimen and, in response to determining that the second specimen is a different slide of the first specimen, ensuring a text editor is the active window. The actions may also include, in response to determining the second specimen is a different from the first specimen, accessing case information for the second specimen, parsing gross description text and placing the cursor at a new cursor location in the report document based at least in part on the gross description text.

In another embodiment of any one of the apparatus above, the actions include accessing case information for a specimen and generating the report document by loading specimen information and the case information into a report template. Generating the report document may include accessing a specimen list and for each specimen in the specimen list, adding a specimen header and a diagnosis placeholder into the report document. Generating the report document may also include automatically typing a diagnosis to replace a diagnosis placeholder based at least in part on a label for a specimen in the specimen list and a gross description.

In a further embodiment of any one of the apparatus above, the actions include accessing case information for the report document and automatically verifying consistency of case information and gross description. Automatically verifying consistency may include determining whether a potential gender error. The actions may also include, in response to detecting a potential inconsistency, notifying a user of the potential inconsistency.

In another embodiment of any one of the apparatus above, the command is a request to finalize and release the report document. The at least one instruction may include instructions to determine that all slides described in a gross description have been scanned.

In a further embodiment of any one of the apparatus above, the current specimen is a first specimen. The actions also include receiving a scanned barcode associated with a second specimen and, in response to receiving the scanned barcode, updating the situational knowledge regarding the second specimen. Updating the situational knowledge may include updating the current patient, the current case, the current specimen and/or the current slide.

In another embodiment of any one of the apparatus above, determining at least one instruction includes accessing at least one dictionary file. Entries in the at least one dictionary file describe the program defined instructions and the user taught instructions. The user taught instructions may include instructions to automatically replace entered text with alternative language. Automatically replacing the entered text may include automatically expanding abbreviations, automatically rearranging an order of words in the entered text, automatically adding a tissue source in front of a label and/or automatically putting in correct procedures for each header in the report document.

In a further embodiment of any one of the apparatus above, the apparatus is embodied in an integrated circuit.

In another embodiment of any one of the apparatus above, the apparatus includes a microphone configured to receive the voice input.

In a further embodiment of any one of the apparatus above, the apparatus includes a monitor configured to display the active window.

Another embodiment provides a computer readable medium for computer-assisted pathology report preparation. The computer readable medium is tangibly encoded with a computer program executable by a processor to perform actions. In response to determining a voice input regarding a report document includes a command for the computer, the actions include determining a current context of the computer. The current context is based at least in part on situational knowledge, the active window and the current cursor location. The situational knowledge includes information regarding a current user, a current patient, a current case, a current specimen and/or a current slide. At least one instruction is determined based on information stored in long-term knowledge data files, the command and the current context. The information stored in the long-term knowledge data files includes program defined instructions and user taught instructions. The actions also include executing the at least one instruction on the computer.

In a further embodiment of the computer readable medium above, the actions include, in response to determining the voice input includes dictation, inputting text into an active window at the current cursor location based on the dictation.

In another embodiment of any one of the computer readable media above, the voice input includes a combination of dictation and at least one command.

In a further embodiment of any one of the computer readable media above, the current specimen is a first specimen. The actions also include receiving a scanned barcode associated with a second specimen and, in response to determining that the second specimen is a different slide of the first specimen, ensuring a text editor is the active window. The actions may also include, in response to determining the second specimen is a different from the first specimen, accessing case information for the second specimen, parsing gross description text and placing the cursor at a new cursor location in the report document based at least in part on the gross description text.

In another embodiment of any one of the computer readable media above, the actions include accessing case information for a specimen and generating the report document by loading specimen information and the case information into a report template. Generating the report document may include accessing a specimen list and for each specimen in the specimen list, adding a specimen header and a diagnosis placeholder into the report document. Generating the report document may also include automatically typing a diagnosis to replace a diagnosis placeholder based at least in part on a label for a specimen in the specimen list and a gross description.

In a further embodiment of any one of the computer readable media above, the actions include accessing case information for the report document and automatically verifying consistency of case information and gross description. Automatically verifying consistency may include determining whether a potential gender error. The actions may also include, in response to detecting a potential inconsistency, notifying a user of the potential inconsistency.

In another embodiment of any one of the computer readable media above, the command is a request to finalize and release the report document. The at least one instruction may include instructions to determine that all slides described in a gross description have been scanned.

In a further embodiment of any one of the computer readable media above, the current specimen is a first specimen. The actions also include receiving a scanned barcode associated with a second specimen and, in response to receiving the scanned barcode, updating the situational knowledge regarding the second specimen. Updating the situational knowledge may include updating the current patient, the current case, the current specimen and/or the current slide.

In another embodiment of any one of the computer readable media above, determining at least one instruction includes accessing at least one dictionary file. Entries in the at least one dictionary file describe the program defined instructions and the user taught instructions. The user taught instructions may include instructions to automatically replace entered text with alternative language. Automatically replacing the entered text may include automatically expanding abbreviations, automatically rearranging an order of words in the entered text, automatically adding a tissue source in front of a label and/or automatically putting in correct procedures for each header in the report document.

In a further embodiment of any one of the computer readable media above, the computer readable medium is a storage medium.

In another embodiment of any one of the computer readable media above, the computer readable medium is a non-transitory computer readable medium (e.g., CD-ROM, RAM, flash memory, etc.).

Various operations described are purely exemplary and imply no particular order. Further, the operations can be used in any sequence when appropriate and can be partially used. With the above embodiments in mind, it should be understood that additional embodiments can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared, and otherwise manipulated.

Any of the operations described that form part of the presently disclosed embodiments may be useful machine operations. Various embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The procedures, processes, and/or modules described herein may be implemented in hardware, software, embodied as a computer-readable medium having program instructions, firmware, or a combination thereof. For example, the functions described herein may be performed by a processor executing program instructions out of a memory or other storage device.

The foregoing description has been directed to particular embodiments. However, other variations and modifications may be made to the described embodiments, with the attainment of some or all of their advantages. It will be further appreciated by those of ordinary skill in the art that modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A method of computer-assisted pathology report preparation, wherein a computer displays a cursor at a current cursor location in an active window, the method comprising:
in response to determining a voice input regarding a report document comprises a command for the computer:
determining a current context of the computer, wherein the current context is based at least in part on situational knowledge, the active window and the current cursor location, wherein the situational knowledge includes information regarding at least one of a current user, a current patient, a current case, a current specimen and a current slide;
determining at least one instruction based on information stored in long-term knowledge data files, the command and the current context, wherein the information stored in the long-term knowledge data files includes program defined instructions and user taught instructions; and
executing the at least one instruction on the computer.

2. The method of claim 1, further comprising in response to determining the voice input comprises dictation, inputting text into the active window at the current cursor location based on the dictation.

3. The method of claim 1, wherein the voice input comprises a combination of dictation and at least one command.

4. The method of claim 1, wherein the current specimen is a first specimen,
the method further comprising:
receiving a scanned barcode associated with a second specimen; and
in response to determining that the second specimen is a different slide of the first specimen, ensuring a text editor is the active window.

5. The method of claim 4, the method comprising, in response to determining the second specimen is a different from the first specimen:
accessing case information for the second specimen;
parsing gross description text; and
placing the cursor at a new cursor location in the report document based at least in part on gross description text.

6. The method of claim 1, further comprising:
accessing case information for a specimen; and
generating the report document by loading specimen information and the case information into a report template.

7. The method of claim 6, wherein generating the report document comprises:
accessing a specimen list; and
for each specimen in the specimen list, adding a specimen header and a diagnosis placeholder into the report document.

8. The method of claim 7, wherein generating the report document comprises automatically typing a diagnosis to replace a diagnosis placeholder based at least in part on a label for a specimen in the specimen list and a gross description.

9. The method of claim 1, further comprising:
accessing case information for the report document; and
automatically verifying consistency of case information and gross description.

10. The method of claim 9, wherein automatically verifying consistency comprises determining whether a potential gender error.

11. The method of claim 9, further comprising, in response to detecting a potential inconsistency, notifying a user of the potential inconsistency.

12. The method of claim 1, wherein the command is a request to finalize and release the report document.

13. The method of claim 12, wherein the at least one instruction comprises instructions to determine that all slides described in a gross description have been scanned.

14. The method of claim 1, wherein the current specimen is a first specimen, the method further comprising:
receiving a scanned barcode associated with a second specimen; and
in response to receiving the scanned barcode, updating the situational knowledge regarding the second specimen.

15. The method of claim 14, wherein updating the situational knowledge comprises updating at least one of: the current patient, the current case, the current specimen and the current slide.

16. The method of claim 1, wherein determining at least one instruction includes accessing at least one dictionary file, wherein entries in the at least one dictionary file describe the program defined instructions and the user taught instructions.

17. The method of claim 16, wherein the user taught instructions include instructions to automatically replace entered text with alternative language.

18. The method of claim 17, wherein automatically replacing the entered text includes:
automatically expanding abbreviations;
automatically rearranging an order of words in the entered text;
automatically adding a tissue source in front of a label; and
automatically putting in correct procedures for each header in the report document.

19. A computer readable medium tangibly encoded with a computer program executable by a processor to perform actions comprising:
in response to determining a voice input regarding a report document comprises a command for the computer:
determining a current context of the computer, wherein the current context is based at least in part on situational knowledge, an active window and a current cursor location, wherein the situational knowledge includes information regarding at least one of a current user, a current patient, a current case, a current specimen and a current slide;
determining at least one instruction based on information stored in long-term knowledge data files, the command and the current context, wherein the information stored in the long-term knowledge data files includes program defined instructions and user taught instructions; and
executing the at least one instruction on the computer.

20. A computer readable medium of claim 19, wherein the actions further comprise, in response to determining the voice input comprises dictation, inputting text into the active window at the current cursor location based on the dictation.
